(19) United States
(12) Patent Application Publication
(10) Pub. No.: US 2013/0340740 A1
(43) Pub. Date: Dec. 26, 2013

(54) CHARCOAL LIGHTING DEVICE

(71) Applicant: Clark S.E. Schaefer, Seattle, WA (US)

(72) Inventor: Clark S.E. Schaefer, Seattle, WA (US)

(21) Appl. No.: 13/527,789

(22) Filed: Jun. 20, 2012

(51) Int. Cl. F23Q 13/04; A47J 37/07

(52) U.S. Cl. 126/25 B

(57) ABSTRACT

A container for containing or supporting a fire starter for use with charcoal, having a base to rest upon the grillwork and upstanding walls to contain a pellet form of starter, and grooves to support a solid form of starter.

### TECHNICAL FIELD

The present invention relates to a device for starting fires, and more particularly to a device to support and contain fuel/lighting material for starting a charcoal fire with or without a charcoal chimney.

### BACKGROUND OF THE INVENTION

Lighting charcoal for a barbeque seems to be a matter of personal preference or perhaps habit. We are all familiar with the petroleum based starter fluid and with the electric starter. Purists insist that a cleaner way of starting charcoal is with newspaper and kindling. More recently a cylindrical device, known as a charcoal chimney, has been introduced, wherein the cylindrical device is horizontally divided, the charcoal is poured into the upper portion and the bottom portion is filled with paper. When the paper is lit, the updraft from the burning paper causes the charcoal to light.

### SUMMARY OF THE INVENTION

With the above-noted prior in mind, it is a goal of the present invention to improve upon the previous lighting technique by providing a container or support for paraffin or alcohol-based lighter, whether solid or pellet forms, such that the lighting material can be placed in stacked charcoal or in the lower portion of the charcoal chimney to replace the newspaper and accelerate the time for lighting the charcoal itself.

It is to be understood that the precise configuration of the container or receptacle may be a matter of design, but is envisioned that the base be rectangular, triangular or circular with at least an upstanding circumferential wall having vertical slots to support the solid fuel starter or to contain a fuel starter such as pellets.

### BRIEF DESCRIPTION OF THE DRAWINGS

FIG. 1 is an isometric view of a triangular-shaped charcoal starting container with a stack of solid fuel starters.

FIG. 2 is a plan view of the starter of FIG. 1.

FIG. 3 is an isometric view of the starter of FIG. 1 with the fuel elements in place for starting a fire.

FIG. 4 is a plan view of the fire starter of FIG. 3.

FIG. 5 is an isometric view of the starter container with a square or rectangular base.

FIG. 6 is a plan view of the starter container of FIG. 5.

FIG. 7 is an isometric view of the starter container of FIG. 5 with the fuel elements in place for starting a fire.

FIG. 8 is a plan view of the starter container of FIG. 7.

FIG. 9 is an isometric view of the starter container with a circular base.

FIG. 10 is a plan view of the starter container of FIG. 9.

FIG. 11 is a view of FIG. 9 with the starter fuel in place.

FIG. 12 is a view of FIG. 10 with the starter fuel in place.

FIG. 13 is an isometric view of a starter chimney with charcoal in place for lighting.

### BEST MODE FOR CARRYING OUT THE INVENTION

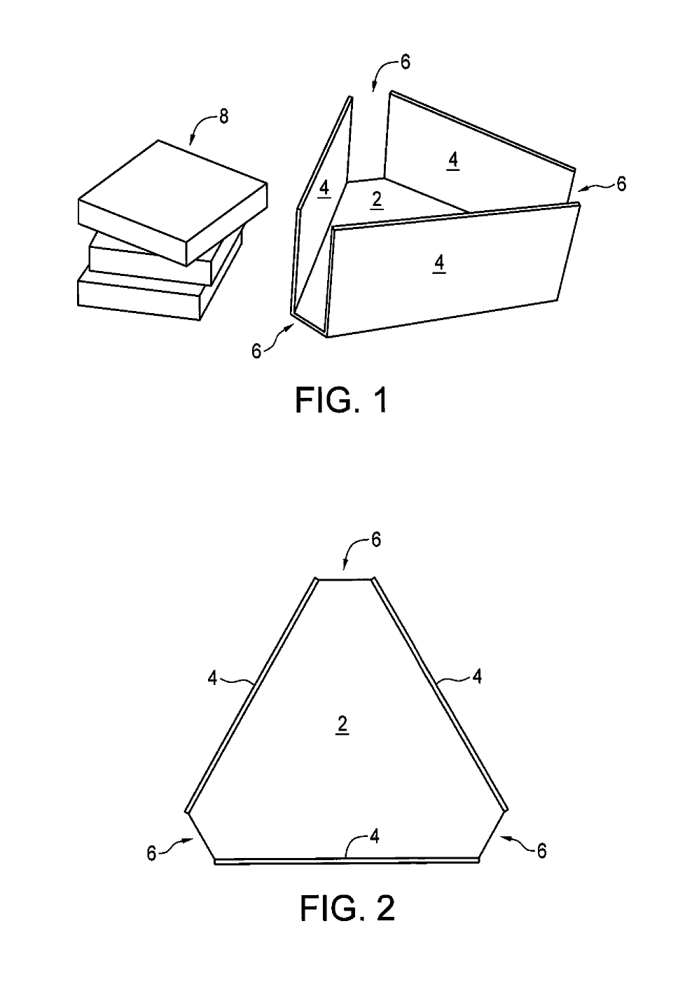

As seen in FIG. 1, the fire starting container or apparatus has a triangular base 2 for shortened side walls 4, three vertical slots 6 to receive the fuel 8. It should be understood that although the fuel illustrated as square or rectangular blocks, the fuel starter could also be in the form of pellets or some other form of paraffin or denatured alcohol based elements which light quickly, burn at a high temperature and leave no residual odor.

FIG. 2 is a plan view of the container of FIG. 1.

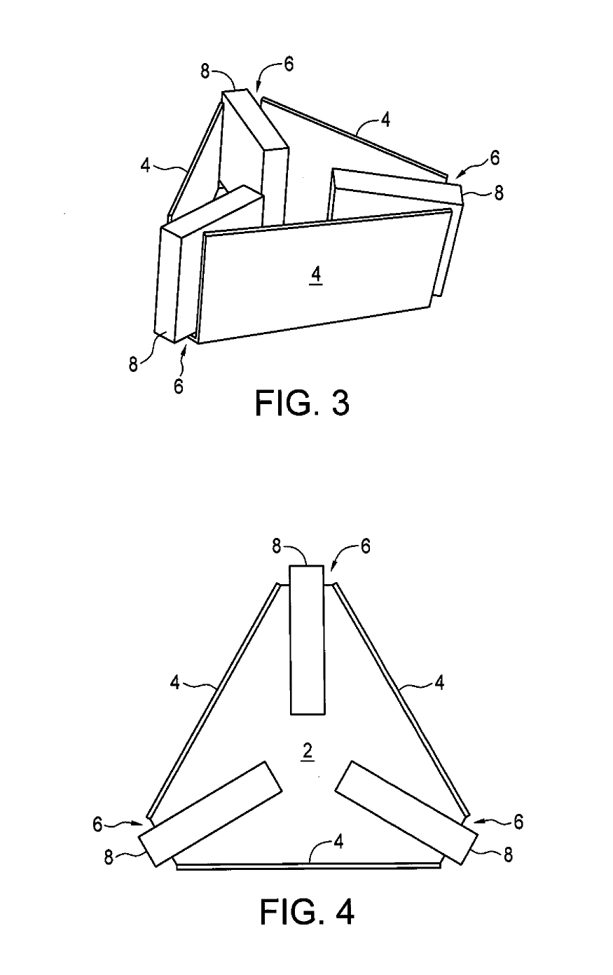

FIGS. 3 and 4 are identical to FIGS. 1 and 2 except that the fuel elements 8 9 are shown in position to light the charcoal.

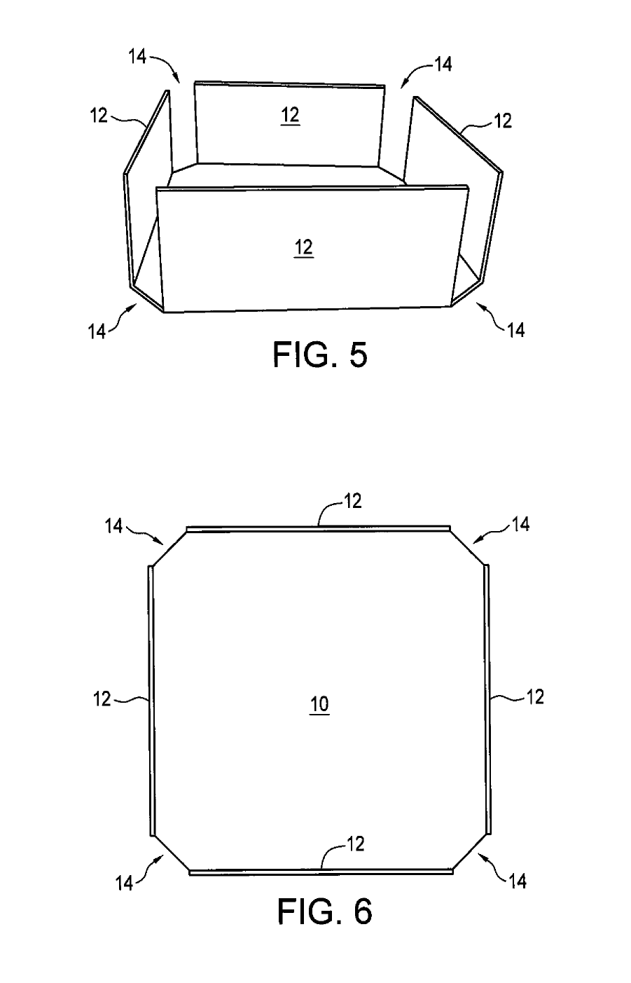

FIGS. 5 and 6 respectively are isometric and plan view of a fuel containment vessel wherein the base 10 is rectangular in configuration and there are four vertical sides 12 and slots 14.

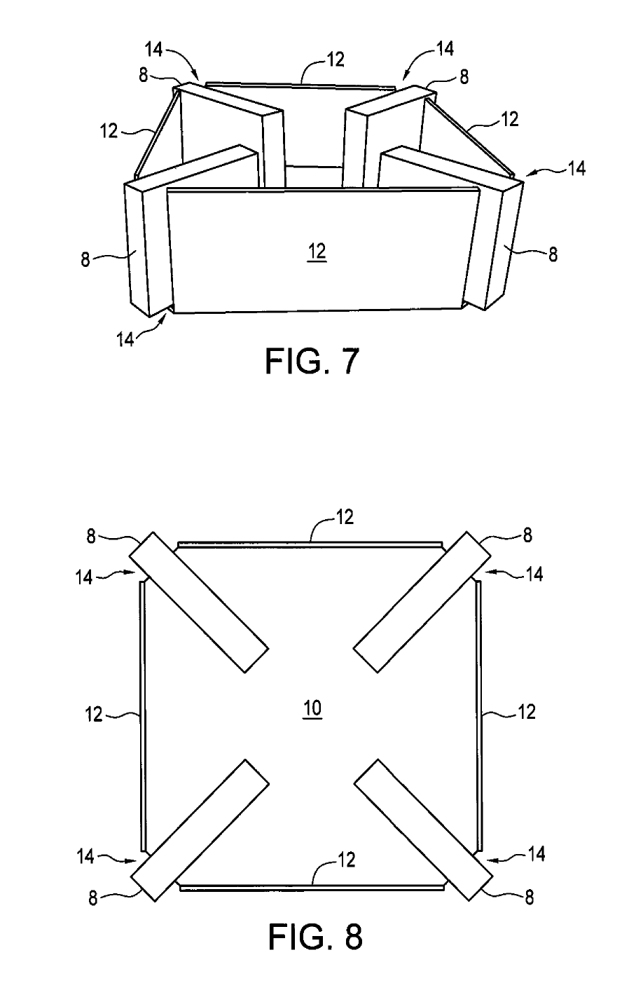

FIGS. 7 and 8 are identical to FIGS. 5 and 6 except that the fuel elements 8 are shown in position.

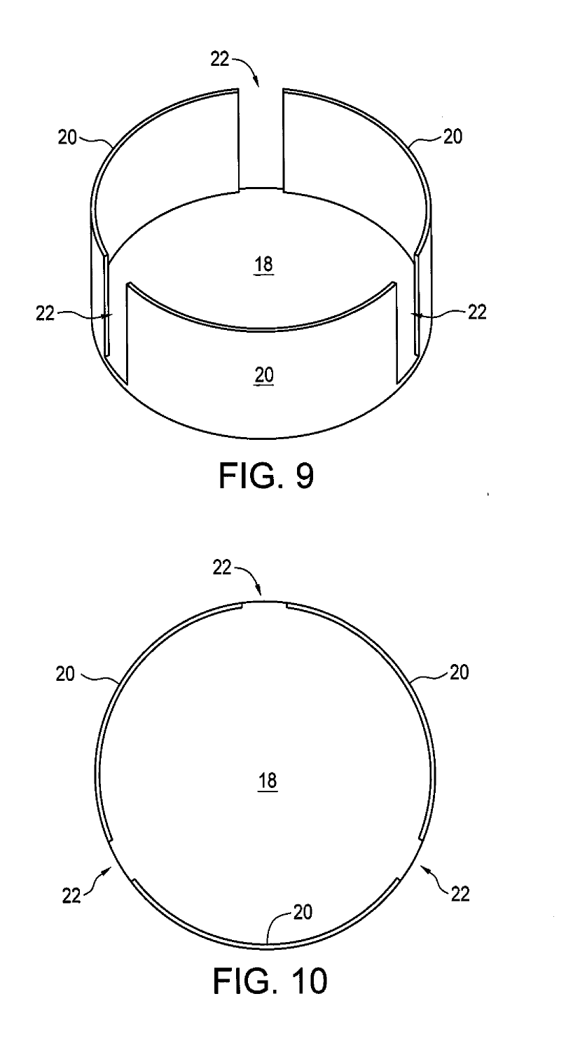

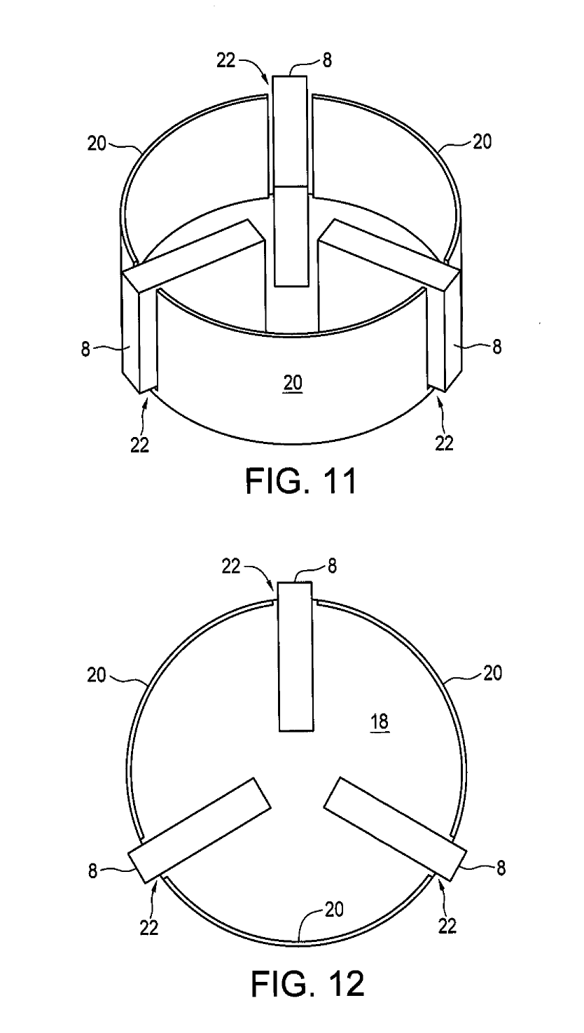

FIGS. 9-12 illustrate another embodiment, wherein the base 18 is circular and the wall 20 is cylindrical, defining a varying number of slots 22 to hold the lighter material 8.

It is to be understood that although the illustrative disclosure deals with a solid rectangular fuel element, these could easily be substituted by pellets which are poured into the container and then utilized in a very similar fashion.

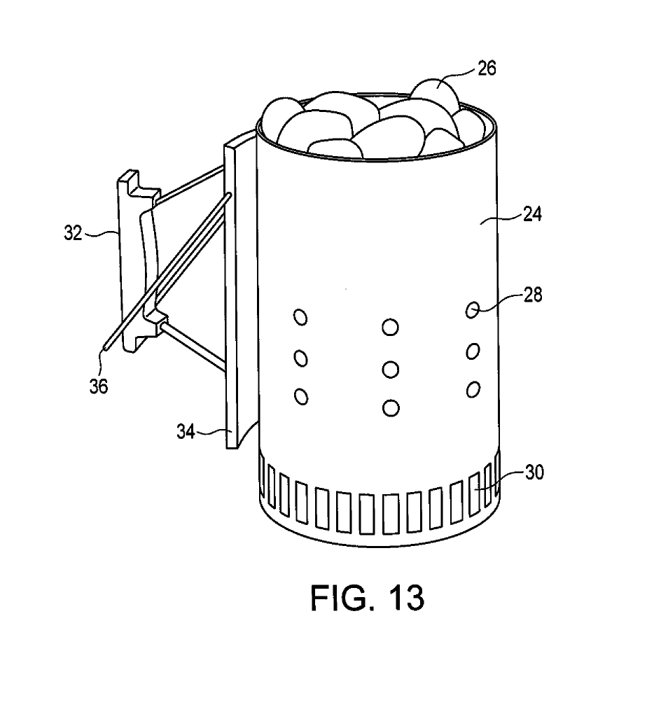

Reference is now had to FIG. 13, wherein, for illustrative purposes, a charcoal chimney is shown having a cylindrical main body portion 24 to hold the charcoal 26. It should be understood that there exists (although not shown) between the vent holes 28 and the vents 30 a grid or grate-shaped floor, which supports the charcoal 26 and under which the fire starter container is located during the lighting process. FIG. 9 also includes a handle 32, a heat shield 34 and a bowl 36.

It is to be understood that the previous description of the current invention contemplates a reusable product, that it is fully within the scope of this invention that the structure could be combustible or even impregnated with paraffin or denatured alcohol to complement the fire starting process.

Although a preferred embodiment has been disclosed for purposes of illustration, it should be understood that various changes and modifications and substitutions could be made in the preferred embodiment without departing from the spirit of the invention as defined by the claims which follow:

What is claimed is:

1. A fuel holder for use with a charcoal chimney lighter, comprising:
a unitary device of a non-combustible material having a flat base and at least three upstanding peripheral walls, said walls being separated, forming vertical slots therebetween, to position and support fire starters.

2. A fuel holder for use with a charcoal grill for lighting the charcoal, comprising:
a flat base of sufficient size to provide stability and prevent the holder from falling between the grill elements; and
vertical wall means having vertical slots to retain and support the fuel during the lighting process.

3. A fuel holder as in claim 1, wherein the base is circular.

4. A fuel holder as in claim 1, wherein the base is triangular.

5. A fuel holder as in claim 1, wherein the base is rectangular.

6. A fuel holder as in claim 2, wherein the base is circular.

7. A fuel holder as in claim 2, wherein the base is triangular.

8. A fuel holder as in claim 2, wherein the base is rectangular.
